(19) United States
(12) Patent Application Publication
(10) Pub. No.: US 2014/0102562 A1
(43) Pub. Date: Apr. 17, 2014

(54) High Pressure OBM Incorporated Valve Assembly

(71) Applicant: Osbiel Morales, Phoenix, AZ (US)

(72) Inventor: Osbiel Morales, Phoenix, AZ (US)

(21) Appl. No.: 14/047,004

(22) Filed: Oct. 6, 2013

Related U.S. Application Data
(60) Provisional application No. 61/710,722, filed on Oct. 7, 2012.

(51) Int. Cl. F16K 37/00

(52) U.S. Cl. CPC F16K 37/0008
USPC 137/557

(57) ABSTRACT

The present invention consists of a valve assembly, designed to manage compressed gasses. It comprises a solid valve body, to which internal and external components attach to work as a unit solving the problem of performing a series of different functions simultaneously. Some of these functions are: To allow and stop the flow of compressed gasses, display the fill pressure of a cylinder, display the outgoing fill pressure, regulate the outgoing flow of compressed gasses, and depressurize the fill line. Any given embodiment of this valve may present all this functions, some of these functions, or any combination thereof.

### FIELD OF INVENTION

A solid valve that stops and allows the flow of compressed gasses into, and out of a vessel and simultaneously displays the pressure inside the vessel, it regulates the outgoing flow of gases leaving the vessel, it displays the outgoing pressure, and depressurizes the fill line. The use of this valve will be mainly but not limited to the filling or recharging of PCP rifles.

### BACKGROUND OF INVENTION

More and more people are choosing Pre-Charged Pneumatic air rifles (PCP) in the U.S. and around the world every year. These rifles have several advantages but they have one big downside; to function properly they need to be filled and refilled with high-pressure compressed air. Up to this point no valve assemblies had been designed for the specific purpose of making possible to fill, refill, bleed, and monitor incoming and outgoing pressure simultaneously.

There are several portable vessels in today's market that hold high-pressure air, usually in the range of 3000-6000 psi. There are also compressors available that work on this pressure range; but; there are no valve assemblies available in the national or international market, specifically designed to satisfy the PCP users' needs.

Today thousands of PCP owners use SCBA and SCUBA cylinders with valves that were designed for diving or emergency respirators. These valves do not have all the components that they require for charging the PCP rifles, as a consequence, a series of components have to be added to the fill line to make them have some of the features the PCP users need. Even with all these components added, the use of these valves creates the following problems:
Special fittings and adapters are needed to connect to the PCP rifles, as these valves do not have quick disconnect fittings, which are standard in PCP rifles.
The pressure in the cylinder in which the valve is installed is not always displayed, as 50% of these valves do not have a cylinder pressure gauge.
The pressure going out of the cylinder in which the valve is installed in never displayed, as all these valves lack an outgoing pressure gauge.
An external bleed valve needs to be attached to the fill line to release its pressure after use, as most of these valves do not have built in bleed valves.
PCP rifles can easily be overcharged, as these valves have no components to regulate the outgoing flow of air when the valve is open.

The valve assembly I designed solves all previously existing problems incorporating all the components that make possible all features that PCP users need. When installed in a cylinder the valve I designed will:
Display the fill pressure of the cylinder at all times.
Display the outgoing pressure to the PCP rifle in a second gauge.
Regulate the outgoing flow of air to reduce or eliminate the possibility of overfilling.
Depressurize the fill line with the onboard bleed valve, after filling the cylinder and after charging a PCP rifle.

### SUMMARY OF THE INVENTION

In accordance with the exemplary embodiment described in this specification, the present invention consists of a solid body valve, which may include but is not limited to comprising the following components: A quick connect fill nipple with an internal one way flow regulator, two gauges, a bleed valve, and a safety burst disk. This invention makes possible to carry out several functions at once: allows and stops the flow of compressed gasses, simultaneously displaying the fill pressure of a cylinder at all times, displaying the outgoing fill pressure in a second gauge, and at the same time regulating the outgoing flow of compressed gasses to reduce or eliminate overfilling; it also depressurizes the fill line prior to disconnecting. Any given embodiment of this valve may present all this functions, some of these functions, or any combination thereof.

### BRIEF DESCRIPTION OF THE DRAWINGS

The exemplary embodiments of the present invention will be described in conjunction with the accompanying drawing figures in which like numerals denote like elements illustrating the following:

FIG. 1 Valve Assembly.

FIG. 2 Valve Assembly Exploded View.

FIG. 3 Valve Body and Components Top View.

FIG. 4 Bleed Valve Exploded View.

FIG. 5 Closed Valve Cross-Sectional View.

FIG. 6 Open Valve Cross-Sectional View.

FIG. 7 Open Bleed Valve Cross-Sectional View.

FIG. 8 One Way Flow Regulator and Quick Disconnect Fill Nipple Cross-Sectional View.

### DETAILED DESCRIPTION

In accordance with an exemplary embodiment and with reference to Figure number 1, the present invention consists of a valve assembly to be used in vessels designed to hold pressurized gasses.

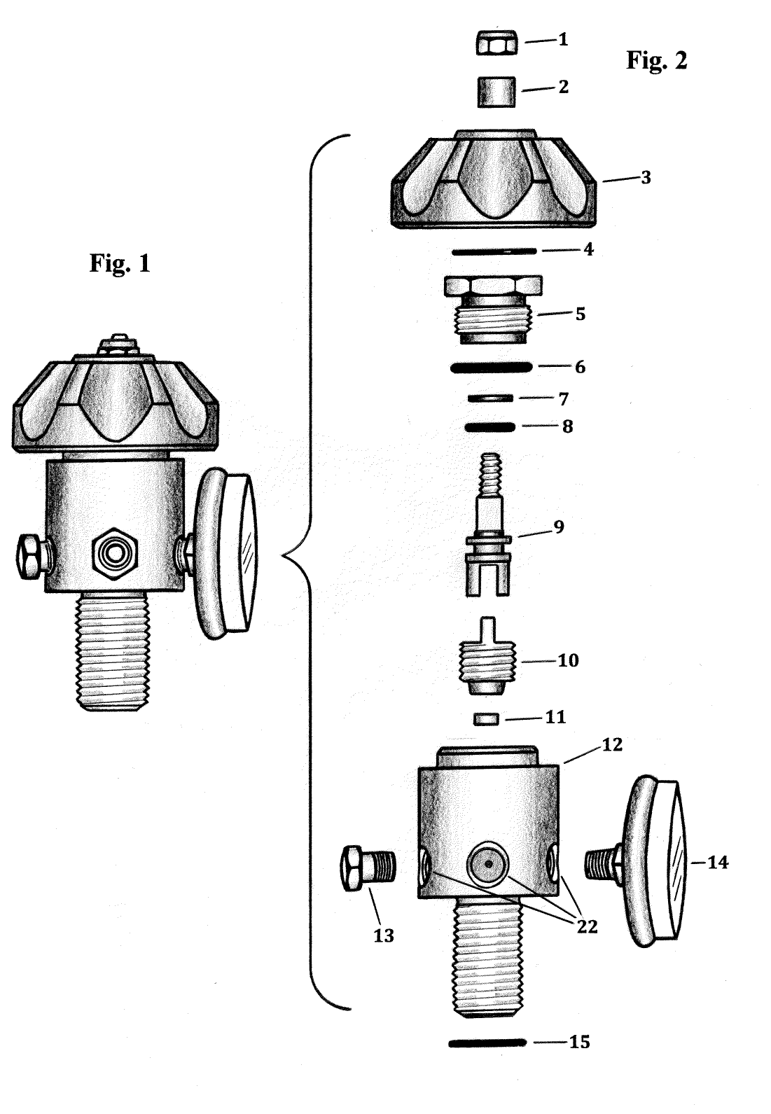

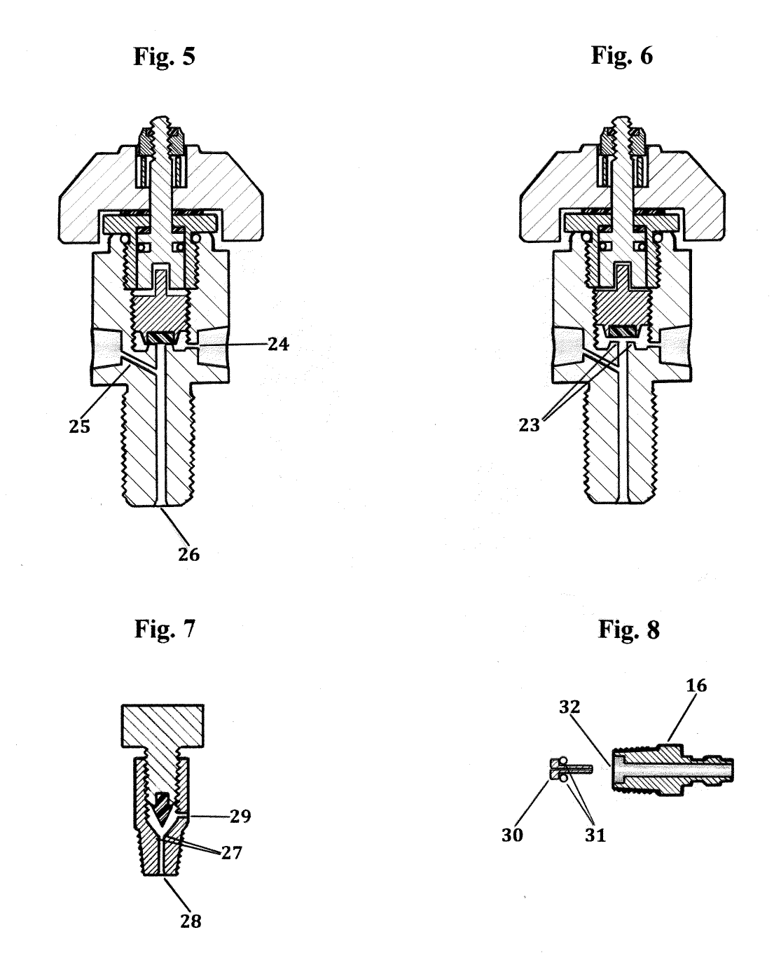

In accordance with an exemplary embodiment the present invention comprises of a solid valve body FIG. 1 part No. 12, which is machined out of a solid piece of metal, preferably lightweight and/or corrosion resistant. The valve body has a cylindrical shape with a male thread on one end, so it can be attached to a cylinder, while the opposite end comprises two concentric threads with a machined seat FIG. 6 part No. 23. Various female connections FIG. 1 Part No. 22 are located in the midsection of the valve body following its circumference to facilitate the attachment of numerous components that will be later explained. The valve has a center orifice longitudinally FIG. 5 Part No. 26, an upper orifice FIG. 5 Part No. 24 and lower orifices FIG. 5 Part No. 25. These orifices allow the flow of gas to the valve components and through the valve itself.

Figure number 2, represents an exploded view of the components and their assembly order. Part No. 15 is the o-ring that seals the valve to the cylinder when installed. Part No. 11 is the soft seat that will allow or stop the flow of gasses through the valve. This part is press fit into a cavity in the lower section the soft seat holder screw Part No. 10. The soft seat is made of delrin or a plastic like material as required to comply with International Standard ISO 10297. Part No. 10 should be machined out of a non-corrosive, friction resistant metal, as its function is to move up and down in the threads when the valve is operated.

Part No. 9 consists of the stem, which connects the soft seat holder screw to the knob. The stem should be machined out of a non-corrosive metal with high tensile strength. Part No. 8 is an o-ring that sits in the stem groove. High durometer o-rings or urethane o-rings work best for this application. Part No. 7 is a delrin friction washer to eliminate drag between the stem and the bonnet Part No. 5. The bonnet should as well be machined utilizing a non-corrosive, friction resistant metal. The bonnet has a hexagon on the top to facilitate proper torquing, and it also has a groove in the outside where the bonnet o-ring sits to seal against the valve body. The only function of the bonnet is to enclose and seal the valve internal components. The bonnet o-ring, Part No. 6, can be any o-ring with a durometer of 70 or higher. The material of this o-ring for this application is not critical.

Part No. 4 is a delrin friction washer that sits between the bonnet and the knob to reduce friction and ensure smooth operation. The knob, Part No. 3, may be a cast or machined piece for which materials and dimensions may vary without having an impact in the valve's performance. The knob does need to have a square opening in the center to connect onto the stem. The spacer, Part No. 2, and a lock nut, Part No. 1 serve to secure the knob in place. The presence of burst disk, Part No. 13, is required by the International Standard ISO 10297, which regulates transportable gas cylinders and cylinder valves. The function of the burst disk is to rupture if the cylinder is overfilled, releasing all the pressure so that the cylinder itself does not fail with catastrophic consequences. The burst disk is mounted on a connection fed by a lower orifice, similar to the one pictured on FIG. 5 No. 25.

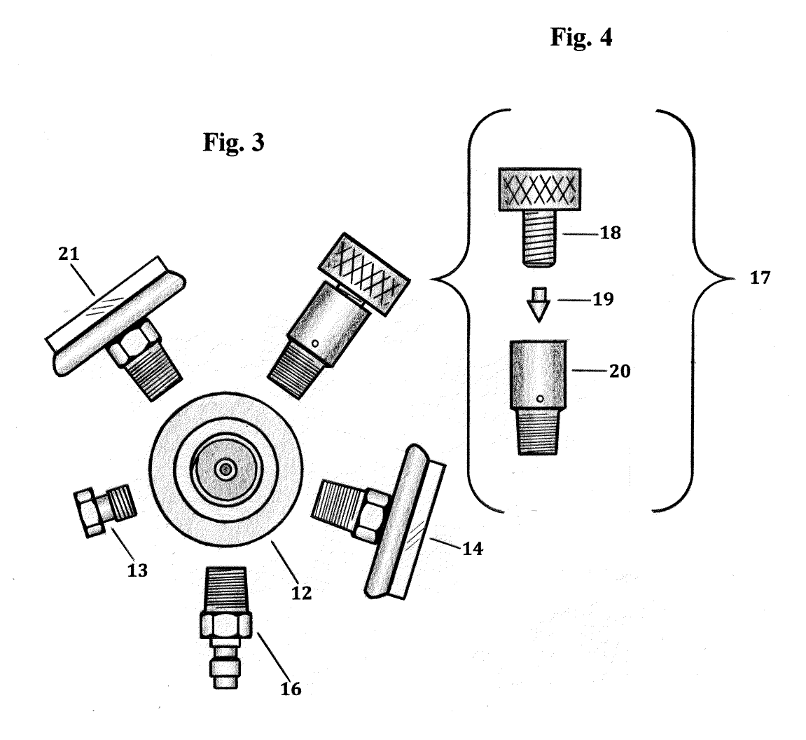

In accordance with this exemplary embodiment the present invention FIG. 3 represents a top view of the valve body and the components that connect to it. Part No. 14 is the gauge that displays the outgoing pressure from the valve. This gauge is fed by means of an upper orifice style connection, FIG. 5 No. 24. The second gauge represented on FIG. 3 Part No. 21 will display at all times the pressure in the cylinder to which the valve is screwed onto. A lower orifice like the one on FIG. 5 No. 25 feeds this gauge.

The quick connect fill nipple FIG. 3 Part No. 16 and FIG. 8, Part No. 16, is used for both, allowing pressure to go to the cylinder through the valve and also for allowing pressure out from the cylinder. This fill nipple is equipped with a one-way flow regulator FIG. 8 Part No. 30. The flow regulator has a small orifice in the center and an o-ring to seal it against the fill nipple orifice. FIG. 8 Part No. 31. Incoming pressure through the fill nipple pushes the flow regulator away from the fill nipple and even when a section of the flow regulator is still inside the fill nipple orifice FIG. 8 No. 32; the air flows through freely into the cylinder. On the other hand outgoing pressure will push the flow regulator against its o-ring FIG. 8 Part No. 31. At this point all the air will have to flow through the extremely small orifice in the center of the flow regulator. This will slow down the filling process and make extremely easy to stop filling at an exact pressure. This also allows extra time for monitoring the fill pressure and closing the valve making the entire process very safe.

FIG. 4 Part No. 17 shows the Bleed valve assembly. The function of the bleed valve is to release the pressure from the lines so that they can be disconnected from the valve assembly after each use. Part No. 18 is the bleed valve knob, which has a cavity to accommodate Part No. 19, the bleed valve soft seat. FIG. 7 illustrates the bleed valve in the open position. Closing the bleed valve is achieved by turning the knob clockwise until the bleed valve soft seat FIG. 4 Part No. 19 sits against the bleed valve seat, FIG. 7 No. 27. By doing so resistance will be felt in the knob and the bleed valve center orifice FIG. 7 No. 28 will be closed impeding compressed air from escaping.

When there is pressure in the line, the bleed valve can be opened by turning the knob counterclockwise. This will move the bleed valve soft seat away from the bleed valve seat and the pressurized gas will escape first through the bleed valve center orifice FIG. 7 No. 28 and then out through the bleed valve relief orifice FIG. 7 No. 29. The bleed valve body, Part No. 20, as well as the bleed valve knob Part No. 18, should be manufactured utilizing a non-corrosive, friction resistant metal. Part No. 19 should be machined out of delrin or a similar plastic like material.

The process of operation of the main valve assembly is fairly simple. After installed, the valve will be operated for two main purposes, filling the cylinder and using the cylinder to fill another vessel.

Process of filling the cylinder: Starting with the valve closed FIG. 5; close the bleed valve. Connect the fill line to the quick connect fill nipple FIG. 3 Part No. 16. Pressurize the line and open the valve assembly by turning the knob Part No. 3 counterclockwise. As the knob is attached to the stem Part No. 9, the stem will rotate on its longitudinal axis and unscrew the soft seat holder screw, Part No. 10, which will move the soft seat away from the valve seat. FIG. 6. Part No. 23. At this point the compressed gasses will flow through the fill nipple FIG. 3 Part No. 16.

The incoming pressure will push the flow regulator FIG. 8 Part No. 30 away from the fill nipple and the compressed gasses will flow through the upper and lower orifices No. 24 and 25, and continue through the center orifice FIG. 5 No. 26 and into the cylinder. In this part of the process the cylinder pressure will be displayed can be monitored in both gauges FIG. 3. Part No. 14 and Part No. 21. When the desired cylinder fill pressure is reached the valve can be closed by turning the knob clockwise. The pressure supply to the line can be closed and now turning the bleed valve knob counterclockwise will open the bleed valve. By doing so the pressurized gas will escape through the bleed valve relief orifice FIG. 7 No. 29. The line can now be disconnected and the filling process is finished.

Process of filling a PCP rifle: Starting with the valve closed FIG. 5. Close the bleed valve. Connect the fill line to the quick connect fill nipple FIG. 3 Part No. 16. Connect the other end of the line to the PCP rifle. Pressurize the line by turning the knob Part No. 3, counterclockwise. As the knob is attached to the stem FIG. 2 Part No. 9, the stem will rotate on its longitudinal axis and unscrew the soft seat holder screw, FIG. 2. Part No. 10, which will move the soft seat FIG. 2 No. 11 away from the valve seat, FIG. 6 No. 23. At this point the compressed gasses will flow from the cylinder through the center orifice FIG. 5 No. 26. The outgoing pressure will push the flow regulator FIG. 8 Part No. 30 against its o-ring FIG. 8 Part No. 31. At this point all the air will have to flow through the extremely small orifice in the center of the flow regulator. This restriction in the flow will slow down the filling process and make extremely easy to stop filling at an exact desired pressure. Remaining pressure in the cylinder will be constantly displayed in the cylinder pressure gauge. FIG. 3 Part No. 21. At the same time the pressure going into the PCP rifle will be displayed on the output pressure gauge FIG. 3. No. 14.

When the desired cylinder fill pressure is reached the valve can be closed by turning the knob, Part No. 3, clockwise. Then turning the bleed valve knob Part No. 18, counterclockwise will open the bleed valve. This will cause the pressurized gas to escape through the bleed valve relief orifice FIG. 7 No. 29. The line can now be disconnected and the filling process is finished.

This valve also has other uses, which could be but are not limited to the following: It can be installed in small compact high-pressure paintball cylinders making them a source of portable air for charging PCP rifles, bicycle tires, motorcycles and ATV tires. This valve can also be installed a larger SCUBA or SCBA cylinder to refill larger vehicles' tires like cars, trucks, and SUVs.

1- I claim an apparatus for carrying out several functions at once; displaying the fill pressure of a cylinder, displaying the outgoing fill pressure, regulating the outgoing flow of compressed gasses, and depressurizes the fill line prior to disconnecting.

2- I claim an apparatus as in claim 1 further comprising of a solid body valve, which may include but is not limited to the following components: A quick connect fill nipple with an internal one way flow regulator, two gauges, a bleed valve, and a safety burst disk.

3- I claim a system that allows and stops the flow of compressed gasses, simultaneously displaying the fill pressure of a cylinder, displaying outgoing fill pressure, regulating the outgoing flow of compressed gasses; and depressurizes the fill line. Any given embodiment of this system may present all this functions, some of these functions, or any combination thereof.
